(19) United States
(12) Patent Application Publication
(10) Pub. No.: US 2015/0198434 A1
(43) Pub. Date: Jul. 16, 2015

(54) METHOD AND APPARATUS FOR MEASURING CRITICAL DIMENSION OF SEMICONDUCTOR

(71) Applicant: Raintree Scientific Instruments (Shanghai) Corporation, Shanghai (CN)

(72) Inventors: Huiping CHEN, Shanghai (CN); Yaoming SHI, Shanghai (CN); Yiping XU, Shanghai (CN)

(73) Assignee: Raintree Scientific Instruments (Shanghai) Corporation

(21) Appl. No.: 14/594,368

(22) Filed: Jan. 12, 2015

(30) Foreign Application Priority Data
Jan. 14, 2014 (CN) 201410016003.4

(51) Int. Cl. G01B 11/02; G01B 11/24

(52) U.S. Cl. CPC G01B 11/02; G01B 11/24

(57) ABSTRACT

A method for measuring critical dimension of semiconductor, includes: acquiring a plurality of measured spectra for signals scattered from a wafer to be measured; determining an average measured spectrum of the plurality of measured spectra; determining a plurality of mean square error (MSE) values each between a corresponding one of the plurality of measured spectra and the average measured spectrum, and defining the one of the plurality of measured spectra corresponding to a maximum one of the plurality of MSE values as a farthest measured spectrum; determining a spectrum matching range including a plurality of library spectra in a spectral library, based on the average measured spectrum and the farthest measured spectrum; and matching the plurality of measured spectra with the library spectra in the spectrum matching range, to determine one or more values of one or more parameters, respectively, for a structure on the wafer.

### CROSS REFERENCE TO RELATED APPLICATION

This application is based upon and claims priority from Chinese Patent Application No. 201410016003.4, filed Jan. 14, 2014, the entire contents of which are incorporated herein by reference.

### TECHNICAL FIELD

The present disclosure generally relates to the field of semiconductor manufacturing and, more particularly, to a method and a device for measuring critical dimension of semiconductor in semiconductor manufacturing.

### BACKGROUND

In the development of manufacturing technology under the 45 nanometer (nm) node, chip foundries and integrated device manufacturers (IDMs) are faced with a lot of metrology challenges. Complete circuit functions and a high operating speed are generally obtained through strict size distribution control. Therefore, successful inline measurement is generally necessary for improving device yield and maintaining profit. However, due to the shrinking of the critical dimension, as well as special measurement requirements for new materials and new manufacturing processes, conventional measurement technologies are facing new challenges. To meet the measurement requirements of rapidity and accuracy for fine structures in the new manufacturing process, new imaging based metrology technologies are used in the measurement of semiconductor topography, such as critical dimension scanning electron microscopy (CD-SEM) and atomic force microscopy (AFM), which realize measurement of the critical dimension and the depth of a trench with high accuracy. However, these new imaging based metrology technologies are generally not used to perform inline measurement, because the measurement process is complex and time consuming, and may damage semiconductor samples. In addition, an optical thin-film measurement instrument is also used in semiconductor measurement, which can measure thicknesses of multiple films of different materials, but generally cannot measure the topography and the lateral dimension of patterns on wafers. In a conventional measuring process, multiple topographic parameters must be obtained by using the CD-SEM, the AFM and the optical film measuring instrument, separately.

In semiconductor device technologies, size characteristics are reflected in particular reference regions on a wafer, and those regions include periodic fine structures that the new manufacturing process needs to precisely control. Through measuring spectra of scattered signals from the periodic fine structures in these particular regions, an optical critical-dimension (OCD) measurement apparatus can determine topographic parameters of the periodic fine structures according to a pre-determined model, such as a circuit structure topographic model. Because the OCD measurement apparatus has the nondestructive nature and can measure multiple parameters simultaneously. Thus, it is widely used in the semiconductor manufacturing industry and is developing towards more rapid and more accurate measurement of finer structures.

The OCD measurement includes first generating a spectral library based on a model and known information from one or more measured wafer samples, and then identifying spectra from the spectral library to optimally match spectra measured by the OCD measurement apparatus from a wafer to be measured, thereby to determine topographic parameters of the structures on the wafer. The measured spectra correspond to scattered signals from, e.g., a periodic fine structure on a reference region of the wafer. Although the material optical property, such as dielectric constant of the fine structure region may not be determined from the spectra directly, a model can be established to incorporate material optical property with one or more parameters, and a numerical calculation method can be used to generate the spectral library including different values of each of the parameters.

For example, a topographic model ν for a periodical structure of a sample can be established according to manufacturing process information of the sample including, e.g., reflective indices and geometry distribution of materials of the sample. The topographic model ν is described with one or more parameters, such as a set of topographic parameters P=(p¹, p², . . . , p^{k}, . . . , p^{K}), where p^{k} is a topographic parameter and K is a number of topographic parameters used in the model. Due to a possible offset of the manufacturing process, a varying range may be set for each topographic parameter p^{k}, such that p^{k} can take a total of Jₖ different values, i.e., p^{k}=(p₁^{k}, p₂^{k}, . . . , pⱼ^{k}, . . . , pⱼ^{k}), where pⱼ^{k} is a j^{th} value of the parameter p^{k}. Thus the total number of the structure topographies is

$${J}_{total} = {\prod }_{k = 1}^{K} {J}_{k} ,$$

i.e., the product from J₁ to J_{K}. If Jₖ is greater than 1, these topographic parameters are referred to as floating parameters, and the critical dimension is usually set as a floating parameter. Additionally, if Jₖ is equal to one, these parameters are considered as fixed parameters in the topographic model ν. Through the numerical calculation, a specific structure topography shape, i.e., each value of the p^{k}, where k is from 1 to K, is determined, can generate one library spectrum, so the library contains the number of Jₜₒₜₐₗ library spectra. Accordingly, νᵢ, where i is from 1 to Jₜₒₜₐₗ, is used to represent the i^{th} structure topography shape and Lᵢ to represent the library spectrum corresponding to the structure topography νᵢ, i.e., Lᵢ=L(νᵢ,λ), and λ represents a plurality of wavelengths of an incident light, λ={λ₁, λ₂, . . . , λₙ, . . . λ_{N}}, where N is the total number of the discrete value of the wavelengths. The numerical calculation for the theoretical spectra may include a Rigorous Coupled Waveguide Analysis (RCWA) algorithm.

A large number of measured spectra S(λ)={s₁(λ), s₂(λ), . . . , s_{q}(λ), s_{Q}(λ)}, where Q is the total number of the measured spectra, can be acquired by the OCD measurement apparatus. If a spectrum in the library can be found to satisfy L(νᵢ,λ)=s_{q}(λ), assuming no measurement noise, the structure model νᵢ is identified as the structure topography of the measured sample. The corresponding values of the parameters p^{k} (k from 1 to K), are considered parameter values for the measured sample.

Match criteria can include a Goodness of Fit (GOF) criterion or a mean square error (MSE) criterion. For example, when the MSE criterion is used, a smaller MSE value indicates more similarity between two spectra. If the MSE value equals to 0, the two spectra are considered totally identical. The MSE value can be calculated as:

$$M S E ( {s}_{q} , {L}_{i} ) = \sqrt{\frac{1}{N} {\sum }_{n = 1}^{N} ( {s}_{q} ( {λ}_{n} ) - {L}_{i} ( {λ}_{n} ) )} . \qquad equation ( 1 )$$

The wavelength scope of the incident light includes N discrete wavelength values from λ₁ to λ_{N}.

With the development of the manufacturing process, the desired measuring precision is higher and higher, and the varying range of the measuring structure parameters is larger and larger. Accordingly, the number of the different values for each parameter Jₖ (k from 1 to K), is greatly increased. Meanwhile, as the new manufacturing process may require a fine pattern structure, more parameters may be needed to describe the structure topography, i.e., the value of K also increases. As a result, the total number Jₜₒₜₐₗ of the spectra in the spectral library can increase to an enormous figure.

FIG. 1 is a flowchart of a traditional method 100 for matching measured spectra with spectra in the spectral library. Referring to FIG. 1, in step 101, a model, such as a topographic model, is established for a measured sample. In step 102, a varying range is set for one or more of parameters of the model. For example, a large range with a small discrete step is generally set for each of the set of parameters. In step 103, a spectral library is generated based on the varying range of each of the parameters. In step 104, measured spectra are acquired by the OCD measurement apparatus for a structure on the wafer to be measured. In step 105, for a current spectrum in the measured spectra, a spectrum is identified from the spectral library to match the current spectrum, thereby to obtain parameter values of a structure corresponding to the spectrum in the spectral library that matches the current spectrum. In step 106, it is judged if a match has been performed for each of the measured spectra. Step 105 is repeated if the current spectrum is not a last one of the measured spectra. Otherwise, step 107 is performed. In step 107, it is judged if any of the obtained parameter values is at a boundary of any varying range set in step 102. For example, the varying range set for one of the parameters may not be appropriate for each measured spectrum. Accordingly, step 102 is re-performed to reset the varying range of the parameter, and following steps 103, 105, and 106 are also re-performed to regenerate the spectral library and match the measured spectra with spectra in the regenerated spectral library. In step 108, if each measured spectrum is matched with a spectrum in the spectral library, and none of the values of the parameters is at the boundary of the varying range, the matching is complete and the match result is output.

For a model corresponding to a simple structure topography with a small number of parameters, each having a small number of different values, or to a small number of discrete wavelength values, the traditional method can be implemented with a local computer having a single processor or multiple processors. However, for a complex model or a spectral library including a tremendous number of spectra, a long time may be needed for the traditional method to perform the match between the measured spectra and the spectra in the spectral library. Assume that a simple structure has K=5 parameters, and each of the 5 parameters has 11 different values, i.e., J₁=J₂=J₃=J₄=J₅=11. There are Jₜₒₜₐₗ=J₁J₂J₃J₄J₅=11⁵=161051 spectra in the spectral library. It will take a lot of time to match a large number, e.g., 100 spectra, of measured spectra with the spectral library. Furthermore, in the traditional method, there is no analysis for the spectral library or the measured spectra before the match is performed. Only after the match process, it is checked if the match results are reliable and, if not, a new match process is started again, which can waste a lot of time.

### SUMMARY

According to a first aspect of the present disclosure, there is provided a method for measuring critical dimension of semiconductor, comprising: acquiring a plurality of measured spectra for signals scattered from a wafer to be measured; determining an average measured spectrum of the plurality of measured spectra; determining a plurality of mean square error (MSE) values each between a corresponding one of the plurality of measured spectra and the average measured spectrum, and defining the one of the plurality of measured spectra corresponding to a maximum one of the plurality of MSE values as a farthest measured spectrum; determining a spectrum matching range including a plurality of library spectra in a spectral library, based on the average measured spectrum and the farthest measured spectrum; and matching the plurality of measured spectra with the library spectra in the spectrum matching range, to determine one or more values of one or more parameters, respectively, for a structure on the wafer.

According to a second aspect of the present disclosure, there is provided a device for measuring critical dimension of semiconductor, comprising: a processor; and a memory for storing instructions executable by the processor, wherein the processor is configured to: acquire a plurality of measured spectra for signals scattered from a wafer to be measured; determine an average measured spectrum of the plurality of measured spectra; determine a plurality of mean square error (MSE) values each between a corresponding one of the plurality of measured spectra and the average measured spectrum, and define the one of the plurality of measured spectra corresponding to a maximum one of the plurality of (MSE) values as a farthest measured spectrum; determine a spectrum matching range including a plurality of library spectra in a spectral library, based on the average measured spectrum and the farthest measured spectrum; and match the plurality of measured spectra with the library spectra in the spectrum matching range, to determine one or more values of one or more parameters, respectively, for a structure on the wafer.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a traditional method for matching measured spectra with spectra in a spectral library.

FIG. 2 is a flowchart of a method for measuring critical dimension of semiconductor, according to an exemplary embodiment.

FIG. 3A is a schematic diagram illustrating a two-dimensional parameter space, according to an exemplary embodiment.

FIG. 3B is a schematic diagram illustrating parameter matching results, according to an exemplary embodiment.

FIG. 4A is a schematic diagram illustrating a distribution of measured spectra, according to an exemplary embodiment.

FIG. 4B is a schematic diagram illustrating parameter matching results, according to an exemplary embodiment.

FIGS. 5A-5D are schematic diagrams illustrating a process to set a weight for each spectrum in a spectral library, according to an exemplary embodiment.

FIG. 6 is a schematic diagram of a simulation structure, according to an exemplary embodiment.

FIG. 7 is a block diagram of a device for measuring critical dimension of semiconductor, according to an exemplary embodiment.

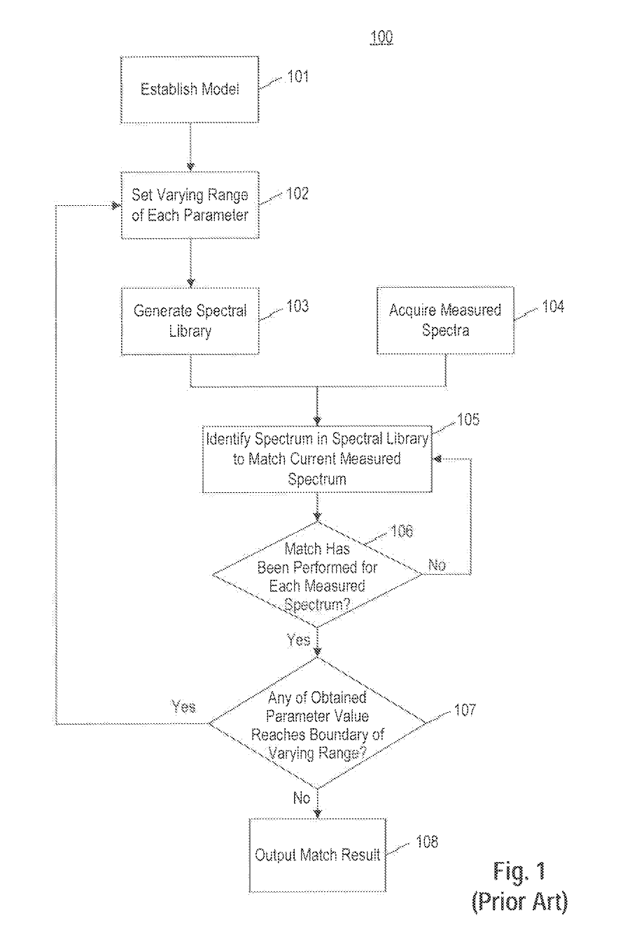

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Although a spectral library may include a large number of spectra corresponding to different structures described by a set of parameters each with a large varying range and a small step size, not all of the spectra in the spectral library are necessarily used to match measured spectra. For example, only those spectra corresponding to parameter values, which surround the accurate values of parameters described the topography of the measured structure on the wafer, are generally useful in the matching progress. The present disclosure takes advantage of this feature to perform the matching, thereby to increase the speed and validity of the matching without scarifying accuracy. Further, the measured spectra in the matching process are similar to each other, because they are generally measured from the same wafer or the same type of wafer, i.e., the measured structures are similar to each other. The number of spectra in the spectral library used in the match progress is greatly decreased and the matching time is reduced.

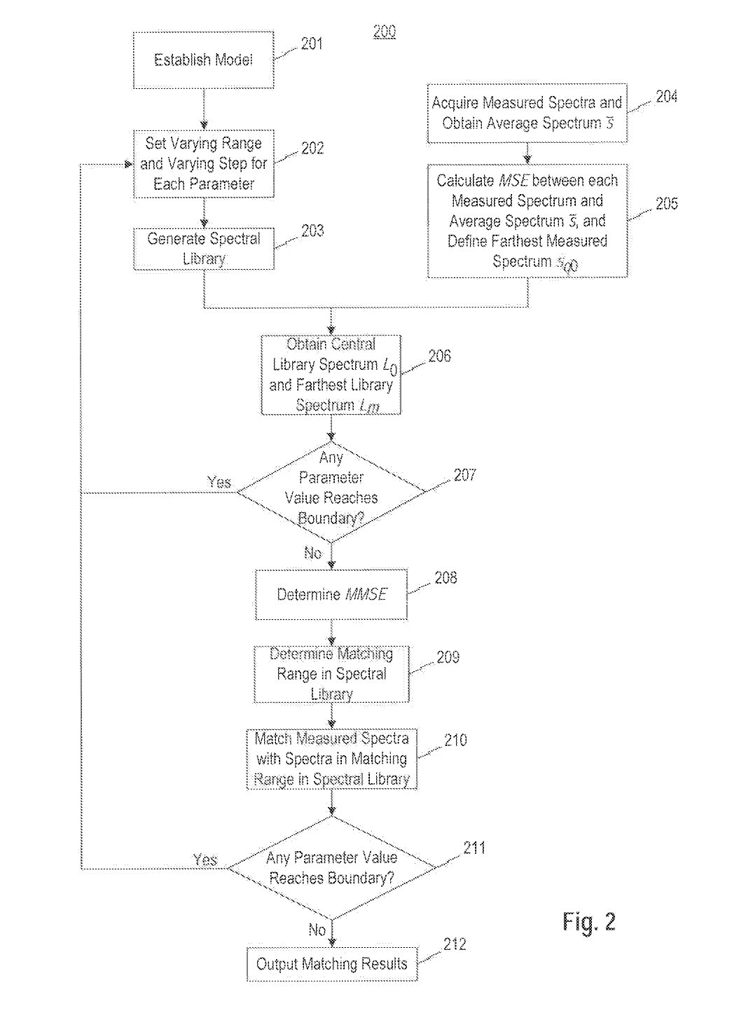

FIG. 2 is a flowchart of a method 200 for measuring critical dimension of semiconductor, according to an exemplary embodiment. For example, a spectral library is generated according to known information of one or more measured wafer samples. An analysis is also performed on a plurality of measured spectra of signals scattered from a wafer to be measured, and a range of spectra in the spectral library is determined for matching the measured spectra, based on an analysis result of the measured spectra. A matching is then performed to match the measured spectra with those spectra in the determined range of the spectral library. In one exemplary embodiment, the method 200 includes the following steps.

In step 201, a model ν, describing a structure topography and a material optical property, is established according to known information regarding one or more measured structure samples. The model ν indicates a relationship between one or more structure parameters, e.g., a set of topographic parameters P, and spectra of wafer scattered signals. In step 202, a varying range and a varying step size are set for each topographic parameter p^{k}, such that each parameter has a plurality of different values. In other words, a plurality of simulation structures are established. In step 203, a spectral library is generated by calculating a plurality of spectra corresponding to the plurality of structures, respectively, based on the model ν.

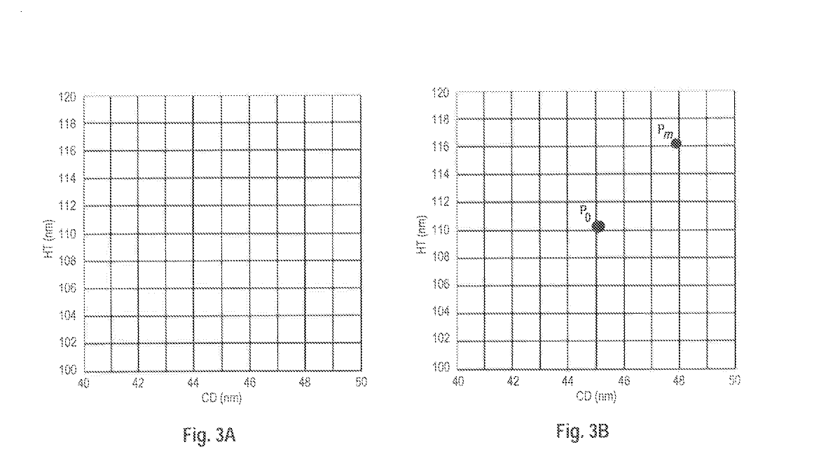

In one exemplary embodiment, the model ν has 5 parameters, with each parameter having 11 different values. Accordingly, the total number of the spectra in the spectral library is 11⁵=161051. FIG. 3A shows a two-dimensional parameter space, including a critical dimension (CD) and a height (HT), according to another exemplary embodiment. In FIG. 3A, each cross point corresponds to a set of discrete values for the corresponding parameters, and a length between two nearest cross points is a step size for a corresponding parameter.

Referring back to FIG. 2, in step 204, a plurality of measured spectra S={s₁, s₂, . . . , s_{q}, . . . , s_{Q}}, where Q is a total number of the measured spectra, are acquired from measuring the scattered signals from structure samples on the wafer to be measured, and an average spectrum s̅ of the plurality of measured spectra S is obtained by an average operation, i.e.,

$$\overline{s} = \frac{1}{Q} {\sum }_{q = 1}^{Q} {s}_{q} .$$

In step 205, a mean square error (MSE) value is calculated between each of the plurality of measured spectra and the average spectrum s̅. The measured spectrum with an index q₀ corresponding to a maximum MSE value, e.g.,

$$M S E ( \overline{s} , {s}_{q 0} ) = {max}_{q ∈ \{ 1 , 2 , … , Q \}} M S E ( \overline{s} , {s}_{q} ) ,$$

is defined as the farthest measured spectrum s_{q0}. For example, if the plurality of measured spectra S include 3 measured spectra, s₁, s₂, and s₃, and the calculated MSE value between s₁ and s₀ is 1, the calculated MSE value between s₂ and s₀ is 2, and the calculated MSE value between s₃ and s₀ is 4, then q₀=3 and the maximum MSE value MSE ( s̅,s₃)=4, and the spectrum s₃ is defined as the farthest spectrum.

In the illustrated embodiment, the MSE value between two spectra is used to define the distance between the two spectra. The maximum MSE value MSE( s̅,s_{q0}) can be identified, and all of the measured spectra are located in a region with a center corresponding to the average spectrum s̅ and a radius corresponding to the maximum MSE value MSE( s̅,s_{q0}). The radius of the region is generally small since the measured spectra are generally similar with each other.

In exemplary embodiments, assuming that there is no measurement error, when a spectrum Lᵢ in the spectral library completely matches a measured spectrum s_{q}, which means that the MSE value between Lᵢ and s_{q} is 0, i.e., MSE(Lᵢ,s_{q})=0, a simulation structure νᵢ corresponding to Lᵢ is considered as the structure on the wafer to be measured. When there is measurement error, even if the simulation structure νᵢ is the same as the structure on the wafer to be measured, and the spectrum Lᵢ in the spectral library matches the measured spectrum s_{q}, MSE(Lᵢ,s_{q}) may not be equal to 0. Therefore, when the MSE value between the spectrum Lᵢ in the spectral library and the measured spectrum s_{q} is approximately 0, Lᵢ and s_{q} can be considered matching each other, and the non-zero MSE value is due to measurement error.

In exemplary embodiments, the difference, i.e., the distance, between the measured spectra mainly originates from measurement error and the differences between measured structures on the wafer samples, while the difference between the spectra in the spectral library is generally from the difference of the simulation structures with different parameter values. The bigger the MSE value between two spectra in the spectral library is, the greater difference between the two simulation structures corresponding to those two spectra, respectively.

In exemplary embodiments, assuming that there is no measurement error, the distance between two measured spectra sₚ and s_{q} is MSE(sₚ,s_{q}). When the measured spectra sₚ and s_{q} match the spectra Lᵢ and Lⱼ in the spectral library, respectively, i.e., MSE(Lᵢ,sₚ)=0 and MSE(Lᵢ,s_{q})=0, Lᵢ is identical with sₚ, and Lⱼ is identical with s_{q} as well. Therefore, MSE(Lᵢ,Lⱼ)=MSE(sₚ,s_{q}).

In exemplary embodiments, when there is measurement error, and the measured spectra sₚ and s_{q} match the spectra Lᵢ and Lⱼ in the spectral library, respectively, the MSE value MSE(Lᵢ,sₚ) is near zero, i.e., MSE(Lᵢ,sₚ)=0, and the MSE value MSE(Lⱼ,s_{q}) is near zero, i.e., MSE(Lᵢ,s_{q})→0, as well. The difference between Lᵢ and sₚ and the difference between Lⱼ and s_{q} mainly originate from measurement error. Generally, the measurement error is small, and the measurement error for two repeated measurements on the same sample is even smaller. The MSE value MSE(Lᵢ,Lⱼ) is therefore approximately equal to the MSE value MSE(sₚ,s_{q}). Therefore, the distribution of the measured spectra is similar to that of their respective matching spectra in the spectral library.

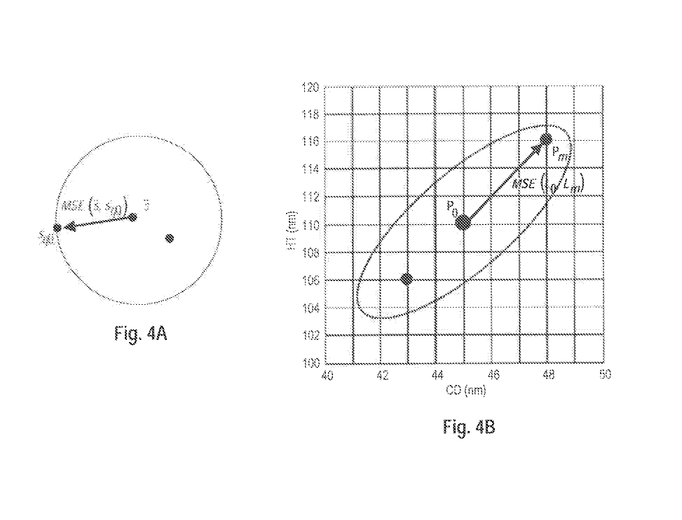

For example, when the two-dimensional parameters are the critical dimension (CD) and the height (HT), as shown in FIG. 4A, the maximum distance between the average spectrum s̅ and the measured spectrum s_{q0} is represented by the maximum MSE value MSE( s̅,s_{q0}). The matching spectrum in the library with s̅ is defined as a center library spectrum L₀, and the matching spectrum in the library with s_{q0} is defined as a farthest library spectrum Lₘ. Thus, the distance between L₀ and Lₘ is the MSE value MSE(L₀,Lₘ), and MSE( s̅,s_{q0}) is approximately equal to MSE(L₀,Lₘ), i.e., MSE( s̅,s_{q0})≈MSE(Lᵢ₀,Lᵢ₁). The matching spectra L₀ and Lₘ in the spectral library correspond to two sets of parameter values, the center parameter set P₀(p₀¹, p₀², . . . , p₀^{k}, . . . , p₀^{K}) and the furthest parameter set Pₘ(pₘ¹, pₘ², . . . , pₘ^{k}, . . . , pₘ^{K}), respectively. As shown in FIG. 4B, for example, the center set of the parameter is P₀(45,110), where K=2 and p₀¹=CD₀=45 nm, p₀²=HT₀=110 nm. When a large number of measured spectra distribute in a region with a center corresponding the average spectrum s̅ and a radius corresponding to the maximum MSE value MSE( s̅,s_{q0}), their respective matching spectra in the spectral library will distribute in a region with a center corresponding to L₀ and a radius corresponding to MSE(L₀,Lₘ). In exemplary embodiments, a region with the center corresponding to L₀ and an increased radius, e.g., a radius corresponding to 1.2×MSE(L₀,Lₘ), can be used to identify each matching spectrum from the spectral library. Spectra out of this region in the spectral library may not be used in matching the plurality of measured spectra.

Still referring to FIG. 2, in step 206, the spectra L₀ and Lₘ in the spectral library matching the average spectrum s̅ and the farthest measured spectrum s_{q0}, respectively, are obtained. The central library spectrum L₀, corresponds to a set of parameter values P₀(p₀¹, p₀², . . . , p₀^{k}, . . . , p₀^{K}), and the farthest library spectrum Lₘ, corresponds to a different set of parameter values Pₘ(pₘ¹, pₘ², . . . , pₘ^{k}, . . . , pₘ^{K}). FIG. 3B shows P₀ and Pₘ in a two-dimensional parameter space, according to an exemplary embodiment.

Referring back to FIG. 2, in step 207, it is checked if any parameter value in the parameter sets P₀(p₀¹, p₀², . . . , p₀^{k}, . . . , p₀^{K}) and Pₘ(pₘ¹, pₘ², . . . , pₘ^{k}, . . . , pₘ^{K}) is at the boundary of the varying range of a corresponding parameter. If so (207-Yes), the matching results are considered not reliable, and step 202 is re-performed to expand the varying range of that parameter to find if there is a better match result. Otherwise (207-No), step 208 is performed.

In step 208, a distance between the central library spectrum L₀ and the farthest library spectrum Lₘ, i.e., MSE(L₀,Lₘ), is calculated, and a distance between the average measured spectrum s̅ and the farthest measured spectrum s_{q0}, i.e., MSE( s̅,s_{q0}), is also calculated. A larger one of MSE(L₀,Lₘ) and MSE( s̅,s_{q0}) is further determined as a maximum mean square error (MMSE). A matching range of the spectral library can then be determined to be a region with a center corresponding to the library spectrum L₀ and a radius corresponding to MMSE. The spectra in the matching range of the spectral library are used in matching the measured spectra.

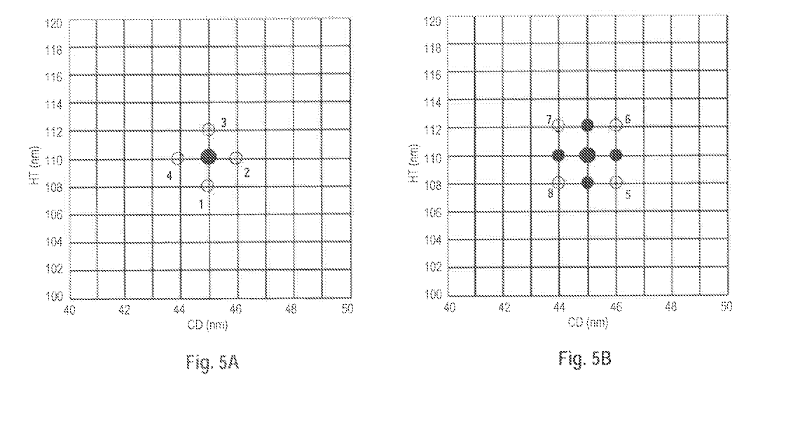

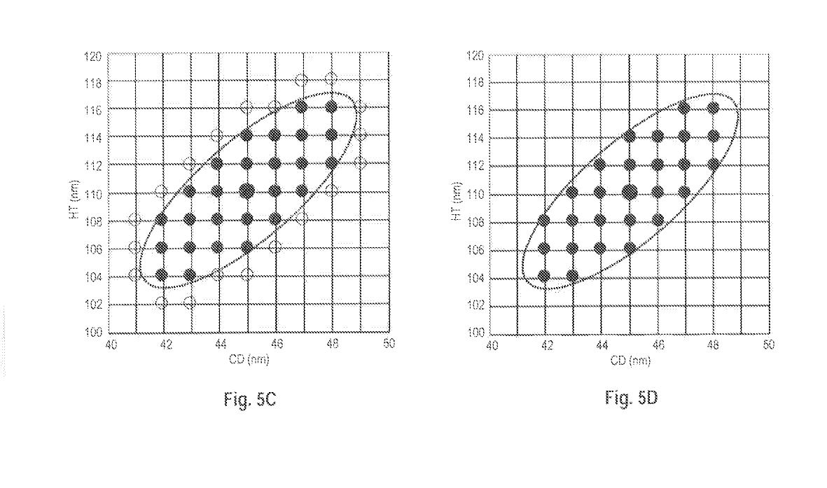

In step 209, a weight is determined for each spectrum in the spectral library, to set if the spectrum is in the matching range, thereby to determine the matching range. A central simulation structure is described by the set of parameter values P₀ corresponding to the central library spectrum L₀. Based on the central simulation structure, surrounded parameter values Pᵢ are selected to calculate the MSE(Lᵢ,L₀) as the MSE value between its corresponding spectrum Lᵢ in the spectral library and the central library spectrum L₀. The weight of the spectrum Lᵢ is set to 1 when the calculated MSE(Lᵢ,L₀) is smaller than or equal to the value of r×MMSE, where r is an adjustment coefficient to adjust the matching range. Otherwise, the weight of the spectrum Lᵢ is set to 0. In one exemplary embodiment, r is equal to any value between 1 and 3, inclusively. P₀ is considered a point in the parameter space and Pᵢ is an arbitrary point surrounding the center of P₀, where (i=1, 2, . . . , y), and y is a total number of points surrounding P₀. The distance between P₀(p₀¹, p₀², . . . , p₀^{k}, . . . , p₀^{K}) and Pᵢ(pᵢ¹, pᵢ², . . . , pᵢ^{k}, . . . , pᵢ^{K}) in the parameter space is

$${[ {\sum }_{k = 1}^{K} ( \frac{{( {p}_{0}^{k} )}^{2} - {( {p}_{i}^{k} )}^{2}}{Δ {p}^{k}} ) ]}^{1 / 2} ,$$

where Δp^{k} is the step size of the parameter p^{k}. Due to that the difference between the spectra in the spectral library is generally from the difference of the simulation structures with different parameter values, the distance of the points represents the difference of the structure which lead to an MSE value for their corresponding spectrum in the spectra library, i.e., the greater distance between P₀ and Pᵢ, the greater MSE value, MSE(Lᵢ,L₀), between their corresponding spectrum L₀ and Lᵢ in the spectra library, respectively. When the weight of a spectrum in the spectral library corresponding to an arbitrary point Pᵢ on a surface of a simply connected, high dimensional, island geometry structure around P₀, a term well known in the field of topology, is equal to 0, the calculation is ended, and the weight of each spectrum in the spectral library corresponding to the points out of that surface is set to zero. The points on a contour of the surface correspond to the MSE value of r×MMSE between the corresponding spectral library and the center library spectrum L₀. For example, in the two-dimensional parameter space shown in FIG. 5C, the hollow dots are on a simply connected multidimensional surface, and the dotted line represents the contour corresponding to r×MMSE. In the illustrated embodiment, the geometry shape of the contour is the simply connected, high dimensional, island geometry structure.

FIGS. 5A-5D are schematic diagrams illustrating a process of setting a weight for each spectrum in the spectral library, according to an exemplary embodiment. In the illustrated embodiment, two parameters, i.e., the critical dimension (CD) and the height (HT), are used in the model ν. In FIG. 5A, the solid dot on the center is a center point P₀ corresponding to a central simulation structure. Points Pᵢ that are the nearest neighbors of the center point P₀, whose distance to P₀ is equal to 1, e.g., the hollow dots marked as 1, 2, 3, 4, are selected. An MSE value between each of these Pᵢ and P₀ is calculated, to determine the weights of the spectra Lᵢ in the spectral library corresponding to these nearest neighbor points, respectively. In this example, the weights of these 4 spectra are all set to 1. Then, next-nearest points, whose distance to P₀ equal to \sqrt{2}, e.g., the hollow dots marked as 5, 6, 7, 8 in FIG. 5B are selected and, similarly, the weights of the spectra in the spectral library corresponding to these next-nearest points, respectably, are determined. This process continues by gradually selecting points outward to determine the weights of the spectra in the spectral library corresponding to the selected points, respectively. As shown in FIG. 5C, when the weight of the spectrum Lᵢ corresponding to an arbitrary point Pᵢ on the simply connected surface around the center point P₀ is determined to be 0, the process ended and the weight of the spectrum Lᵢ corresponding to any point out of this surface is set to zero directly. As shown in FIG. 5C, the solid dots correspond to the spectra in the spectral library whose weights are determined to be 1, and the hollow dots correspond to the spectra in the spectral library whose weights are determined to 0. The weights of the spectra in the spectral library corresponding to all other cross points in FIG. 5C are directly defined as 0. The solid dots shown in FIG. 5D are the parameter values corresponding to the spectra in the spectral library that are used to match the measured spectra.

Referring back to FIG. 2, in step 210, each spectrum s_{q} in the plurality of measured spectra S with a total number Q, is matched with a spectrum in the spectral library that has a weight of 1, i.e., a spectrum in the matching range of the spectral library. In the example shown in FIG. 5D, only the spectra in the spectral library corresponding to the solid dots are used in matching each spectrum in the measured spectra S.

In step 211, after each spectrum in the measured spectra S is matched with a spectrum in the spectral library that has a weight of 1, the matching results, e.g., the parameter values p^{k} (k=1, 2, . . . , K, where K is the total number of parameters to describe the model ν) are checked. If any of the parameter values p^{k} is at the boundary of the varying range of a parameter (211-Yes), step 202 is re-performed to modify the varying range of the parameter to optimize the spectral library, and to redo the matching process. Otherwise (211-No), in step 212, the matching results are determined as the critical dimension values of the measured samples, respectively.

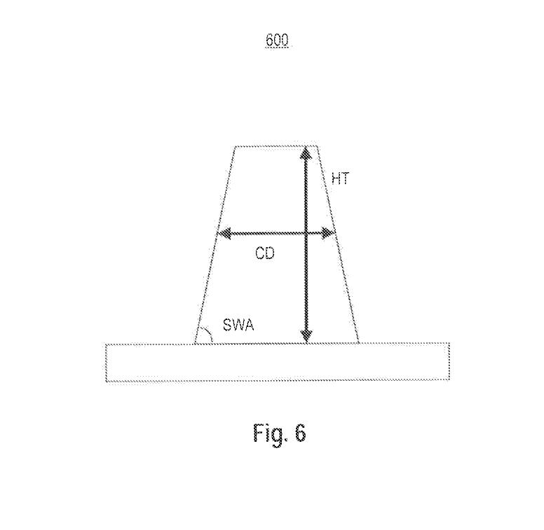

FIG. 6 is a schematic diagram of a simulation structure 600, according to an exemplary embodiment. In the illustrated embodiment, the simulation structure 600 has 3 parameters, e.g., a critical dimension (CD), a height (HT), and a side wall angle (SWA). The varying range of each of the parameters is set such that, e.g., the CD has 71 different values, the HT has 21 different values, and the SWA has 13 different values. A spectral library can thus be established with 19383 spectra corresponding to 19383 simulation structures, respectively. In the illustrated embodiment, there are 71 similar structure samples, and each sample has 10 measured spectra. The traditional method will traverse the whole library for matching each of the 710 (71×10) measured spectra, to obtain parameter values.

Based on the method 200 (FIG. 2), these 710 measured spectra are first analyzed to obtain an average measured spectrum i and a farthest measured spectrum s_{q0} with a distance MSE( s̅,s_{q0}) between s̅ and s_{q0}. The average measured spectrum s̅ and the farthest measured spectrum s_{q0} are matched with a central library spectrum L₀ and a farthest spectrum Lₘ in the spectral library, corresponding to two sets of parameter values P₀ and Pₘ respectively. It is checked if any parameter value in P₀ and Pₘ is at the boundary of the varying range of this parameter. In the illustrated embodiment, it is assumed that no parameter value is at the boundary. Otherwise, the corresponding varying range will be modified to regenerate the spectral library. A distance between L₀ and Lₘ in the spectral library, e.g., MSE(L₀,Lₘ), is determined and compared with MSE( s̅,s_{q0}), and a larger one of MSE(L₀,Lₘ) and MSE( s̅,s_{q0}) is defined as MMSE. In the parameter space, point Pᵢ, corresponding to the spectrum Lᵢ in the spectral library, are selected gradually outward from the center point P₀. The value MSE(L₀,Lᵢ), the MSE between each Lᵢ and the central spectrum L₀, is calculated. In the illustrated embodiment, the weight of Lᵢ is determined to be 1 if MSE(L₀,Lᵢ)≦1.5×MMSE, and 0 otherwise. There are 2580 spectra determined to have a weight of 1 in the illustrated embodiment. In other words, only 13.31% of the spectra in the spectral library are usable in the matching progress. Each of the measured spectra can then be matched with a spectrum in the spectral library that has a weight of 1. It is further checked if any value in the matching results is at the boundary of the varying range of a parameter. If not, the matching progress is ended and the matching results, e.g., the parameter values p^{k}(k=1, 2, . . . . K), are determined as the structure parameter values of the measured samples.

Table 1 below is a comparison of time for matching between the method 200 (FIG. 2) and the traditional method. Although the method 200 adds an analysis for the measured spectra and the spectral library, an amount of time used by the analysis is small compared to the time used in the matching process. With the increase of the number of measured spectra, the amount of time used for the analysis becomes less and less compared to the time used in the matching progress, as shown in Table 1, and more and more time is saved by the method 200.

TABLE 1
Matching Time Comparison between Traditional
Method and Method 200 (FIG. 2)

| No. of | Time Used in Traditional | Time Used in Method |
|---|---|---|
| Measured Spectra | Method (second) | 300 (second) |
| 10 | 12.07 | 3.10 |
| 71 | 93.49 | 60.39 |
| 142 | 184.86 | 122.41 |
| 213 | 272.10 | 163.30 |
| 355 | 535.57 | 281.94 |
| 710 | 1251.25 | 629.46 |

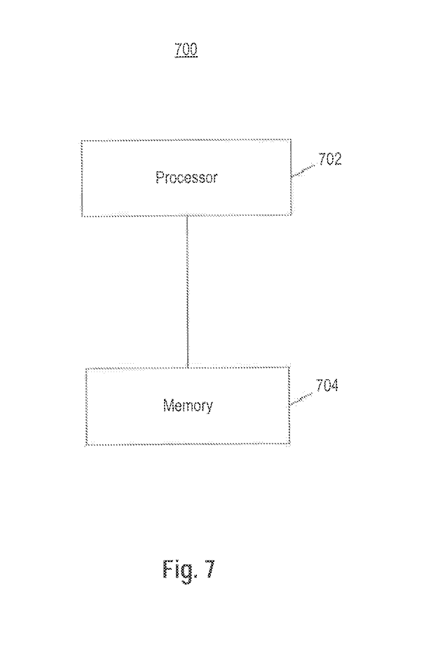

FIG. 7 illustrates a block diagram of a device 700, according to an exemplary embodiment. Referring to FIG. 7, the device 700 includes a processor 702 configured to execute program instructions to perform the above described method 200 (FIG. 2), and a memory 704 for storing the program instructions.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. 11 is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for measuring critical dimension of semiconductor, comprising:
acquiring a plurality of measured spectra for signals scattered from a wafer to be measured;
determining an average measured spectrum of the plurality of measured spectra;
determining a plurality of mean square error (MSE) values each between a corresponding one of the plurality of measured spectra and the average measured spectrum, and defining the one of the plurality of measured spectra corresponding to a maximum one of the plurality of MSE values as a farthest measured spectrum;
determining a spectrum matching range including a plurality of library spectra in a spectral library, based on the average measured spectrum and the farthest measured spectrum; and
matching the plurality of measured spectra with the library spectra in the spectrum matching range, to determine one or more values of one or more parameters, respectively, for a structure on the wafer.

2. The method of claim 1, wherein the determining of the spectrum matching range in the spectral library comprises:
determining a first library spectrum in the spectral library as a central library spectrum to match the average measured spectrum;
determining a second library spectrum in the spectral library as a farthest library spectrum to match the farthest measured spectrum;
determining an MSE value between the central library spectrum and the farthest library spectrum;
determining, as a maximum mean square error (MMSE), a larger one of the MSE value between the central library spectrum and the farthest library spectrum, and the MSE value between the average measured spectrum and the farthest measured spectrum; and
determining the spectrum matching range in the spectral library based on the central library spectrum and the MMSE.

3. The method of claim 2, further comprising:
establishing a model including the one or more parameters, as a set of parameters, based on known information regarding one or more wafer samples; and
generating the spectral library based on the model.

4. The method of claim 3, wherein the generating comprises:
setting a varying range for each parameter in the set of parameters for the model, the varying range including a boundary of the parameter; and
generating the spectral library based on the model and a plurality of different values of each of the set of parameters in the corresponding varying range.

5. The method of claim 4, wherein the central library spectrum corresponds to a central set of parameter values, and the farthest library spectrum corresponds to a farthest set of parameter values, the method further comprising:
determining whether any parameter value in the central set of parameter values and the farthest set of parameter values is at the boundary of the parameter; and
if it is determined that no parameter value in the central set of parameter values and the farthest set of parameter values is at the boundary, performing the determining of the MMSE and the determining of the spectrum matching range in the spectral library based on the central library spectrum and the MMSE.

6. The method of claim 5, further comprising:
if it is determined that a parameter value in the central set of parameter values and the farthest set of parameter values is at the boundary of the parameter, expanding the varying range of the parameter; and
regenerating the spectral library.

7. The method of claim 5, wherein the determining of the spectrum matching range in the spectral library based on the central library spectrum and the MMSE comprises:
determining an MSE value MSE(L₀,Lᵢ) between an i^{th} library spectrum Lᵢ in the spectral library and a central library spectrum L₀, the i^{th} library spectrum corresponding to an i^{th} set of parameter values in a vicinity of the central set of parameter values;
setting, if MSE(L₀,Lᵢ)≦r×MMSE, a weight for the i^{th} library spectrum to 1, to determine that the i^{th} library spectrum is in the spectrum matching range in the spectral library; and
setting, if MSE(L₀,Lᵢ)>r×MMSE, the weight for the i^{th} library spectrum to 0, to determine that the i^{th} library spectrum is not in the spectrum matching range in the spectral library;
wherein r is an adjustment coefficient.

8. The method of claim 7, further comprising:
determining whether a parameter value of a parameter in the set of parameters is at the boundary of the parameter;
if it is determined that the parameter value is at the boundary, expanding the varying range of the parameter, and regenerating the spectral library; and
if it is determined that the parameter value is not at the boundary, outputting the parameter value.

9. The method of claim 7, further comprising:
setting a value of the adjustment coefficient between 1 and 3, inclusively.

10. The method of claim 7, further comprising:
if the weight for the i^{th} library spectrum is set to 0, and the i^{th} h library spectrum corresponds to any point, in a parameter space, on a simply connected, high-dimension, island geometrical surface surrounding the central point corresponding to the parameter values in the central set of parameters, setting weights for respective remaining library spectra corresponding to points outside the simply connected, high-dimension, island geometrical surface to 0, to determine that the remaining library spectra are not in the spectrum matching range in the spectral library.

11. The method of claim 7, wherein the determining of the MSE value MSE(L₀,Lᵢ) comprises:
starting from the central library spectrum corresponding to a central point in a parameter space, gradually selecting outward a point in the parameter space corresponding to the i^{th} library spectrum in the spectral library, to calculate the MSE value MSE(L₀,Lᵢ) between the i^{th} library spectrum and the central library spectrum.

12. A device for measuring critical dimension of semiconductor, comprising:
a processor; and
a memory for storing instructions executable by the processor,
wherein the processor is configured to:
acquire a plurality of measured spectra for signals scattered from a wafer to be measured;
determine an average measured spectrum of the plurality of measured spectra;
determine a plurality of mean square error (MSE) values each between a corresponding one of the plurality of measured spectra and the average measured spectrum, and define the one of the plurality of measured spectra corresponding to a maximum one of the plurality of MSE values as a farthest measured spectrum;
determine a spectrum matching range including a plurality of library spectra in a spectral library, based on the average measured spectrum and the farthest measured spectrum; and
match the plurality of measured spectra with the library spectra in the spectrum matching range, to determine one or more values of one or more parameters, respectively, for a structure on the wafer.

13. The device of claim 12, wherein the processor is further configured to:
determine a first library spectrum in the spectral library as a central library spectrum to match the average measured spectrum;
determine a second library spectrum in the spectral library as a farthest library spectrum to match the farthest measured spectrum;
determine an MSE value between the central library spectrum and the farthest library spectrum;
determine, as a maximum mean square error (MMSE), a larger one of the MSE value between the central library spectrum and the farthest library spectrum, and the MSE value between the average measured spectrum and the farthest measured spectrum; and
determine the spectrum matching range in the spectral library based on the central library spectrum and the MMSE.

14. The device of claim 13, wherein the processor is further configured to:
establish a model including the one or more parameters, as a set of parameters, based on known information regarding one or more wafer samples; and
generate the spectral library based on the model.

15. The device of claim 14, wherein the processor is further configured to:
set a varying range for each parameter in the set of parameters for the model, the varying range including a boundary for each parameter; and
generate the spectral library based on the model and a plurality of different values of each of the set of parameters in the corresponding varying range.

16. The device of claim 15, wherein the central library spectrum corresponds to a central set of parameter values, and the farthest library spectrum corresponds to a farthest set of parameter values, the processor being further configured to:
determine whether any parameter value in the central set of parameter values and the farthest set of parameter values is at the boundary of the parameter; and
if it is determined that no parameter value in the central set of parameter values and the farthest set of parameter values is at the boundary, perform the determining of the MMSE and the determining of the spectrum matching range in the spectral library based on the central library spectrum and the MMSE.

17. The device of claim 16, wherein the processor is further configured to:
if it is determined that a parameter value in the central set of parameter values and the farthest set of parameter values is at the boundary of the parameter, expand the varying range of the parameter; and
regenerate the spectral library.

18. The device of claim 16, wherein the processor is further configured to:
determine an MSE value MSE(L₀,Lᵢ) between an the i^{th} library spectrum Lᵢ in the spectral library and a central library spectrum L₀, the i^{th} h library spectrum corresponding to an i^{th} set of parameter values in a vicinity of the central set of parameter values;
set, if MSE(L₀,Lᵢ)≦r×MMSE, a weight for the i^{th} library spectrum to 1, to determine that the i^{th} library spectrum is in the spectrum matching range in the spectral library; and
set, if MSE(L₀,Lᵢ)>r×MMSE, the weight for the i^{th} library spectrum to 0, to determine that the i^{th} library spectrum is not in the spectrum matching range in the spectral library;
wherein r is an adjustment coefficient.

19. The device of claim 18, wherein the processor is further configured to:
determine whether the a parameter value of a parameter in the set of parameters is at the boundary of the parameter;
if it is determined that the parameter value is at the boundary, expand the varying range of the parameter, and regenerate the spectral library; and
if it is determined that the parameter value is not at the boundary, output the parameter value.

20. The device of claim 18, wherein the processor is further configured to:
set a value of the adjustment coefficient between 1 and 3, inclusively.
